(19) United States
(12) Patent Application Publication
(10) Pub. No.: US 2012/0024836 A1
(43) Pub. Date: Feb. 2, 2012

(54) HEATING APPARATUS

(75) Inventors: SHANG-MING ZHANG, Shenzhen City (CN); CHANG-QING YIN, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/940,152

(22) Filed: Nov. 5, 2010

(30) Foreign Application Priority Data
Jul. 28, 2010 (CN) 201010239091.6

(51) Int. Cl. A21B 1/00

(52) U.S. Cl. 219/400

(57) ABSTRACT

A heating apparatus includes a oven. The oven includes a box, a motor, a fan chamber, an air duct and a heater. The box defines a cavity. The motor includes a fan. The motor is attached to the box. The fan chamber is fixed in the cavity and defines a inlet and a outlet. The air duct includes a first air hole and a second air hole. The first air hole communicates with the outlet, and the second air hole communicates with the cavity. The heater is received in the air duct. The motor drives the fan to absorb air from the inlet of the fan chamber and blow the air into the air duct. The air is heated by the heater and flows from the second air hole.

### BACKGROUND

1. Technical Field

The exemplary disclosure generally relates to heating apparatus, particularly, to a heating apparatus for softening a plastic member so that a metal member joined to the plastic can be easily removed.

2. Description of Related Art

Many products contain both metal and plastic that were joined in an injection molding process. When the products are no longer needed, they should be recycled by separating the plastic and the metal parts. However, this separation may require great force and therefore be difficult and may damage the plastic and metal materials.

Therefore, there is room for improvement within the art.

### BRIEF DESCRIPTION OF THE DRAWINGS

Many aspects of the heating apparatus can be better understood with reference to the following drawings. The components in the drawings are not necessarily drawn to scale, the emphasis instead being placed upon clearly illustrating the principles of the heating apparatus.

FIG. 1 is an isometric view of a heating apparatus, in accordance with an exemplary embodiment.

FIG. 2 is an exploded, isometric view of a oven shown in FIG. 1.

FIG. 3 is an assembled, isometric view of the oven shown in FIG. 1, but shown from another aspect.

FIG. 4 is a cross section view taken along line IV-IV of FIG. 3.

### DETAILED DESCRIPTION

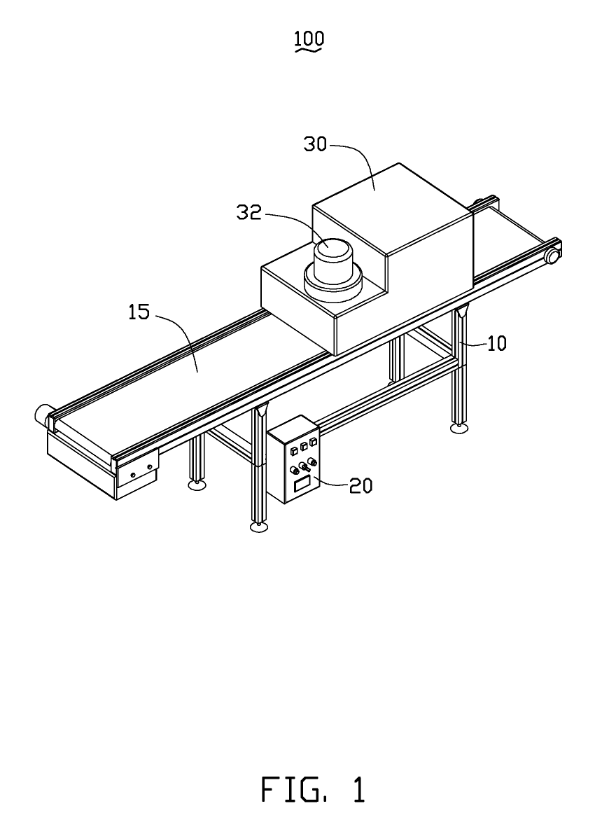

FIG. 1 shows an exemplary embodiment of a heating apparatus 100 for heating workpieces (not shown) made, for example, of metal and plastic. The heating apparatus 100 includes a frame 10, a controller 20, and a oven 30. The controller 20 is attached to one side of the frame 10.

The frame 10 including a conveyor belt 15 controlled by the controller 20. The oven 30 can be attached to the frame 10 and is positioned above the conveyor belt 15.

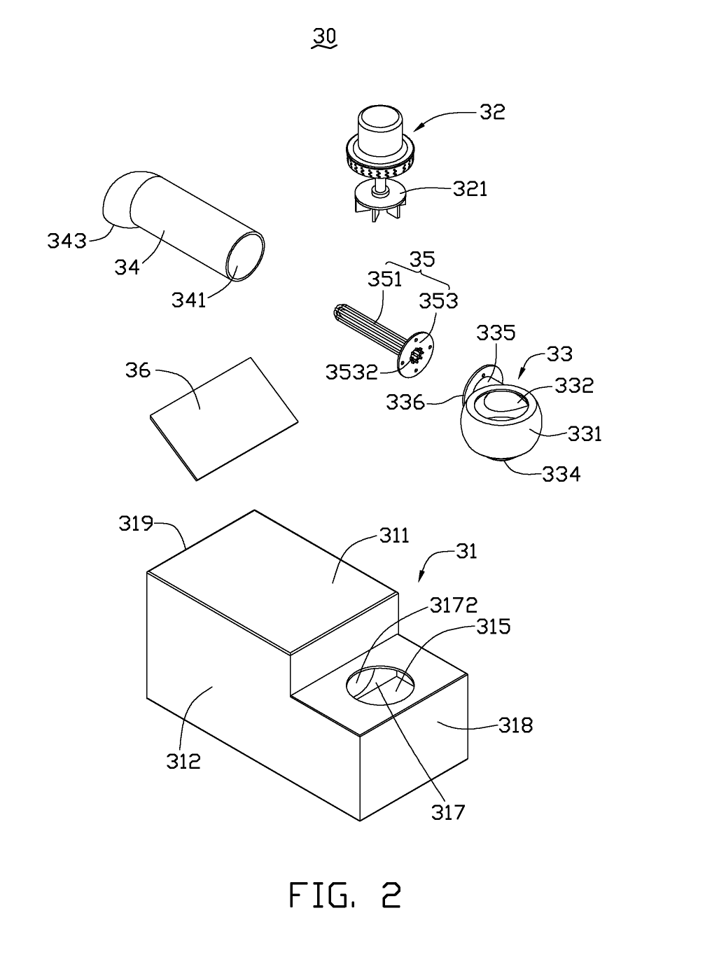

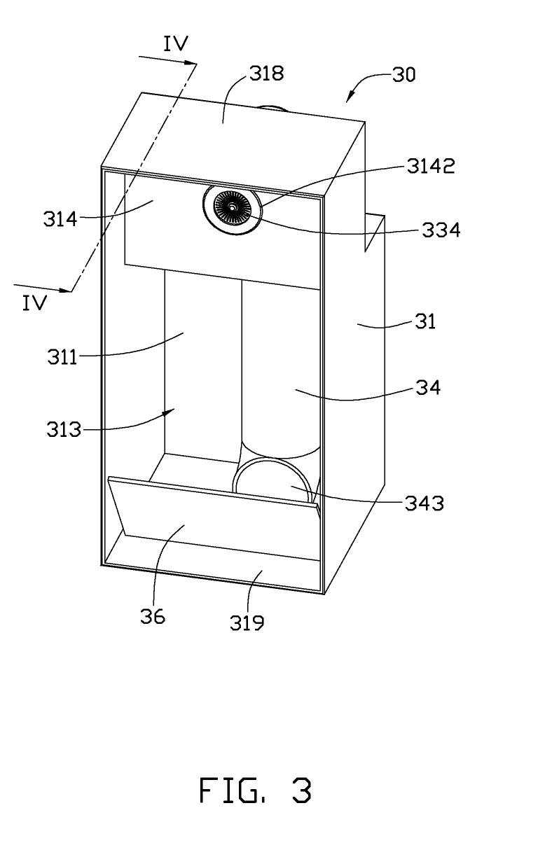

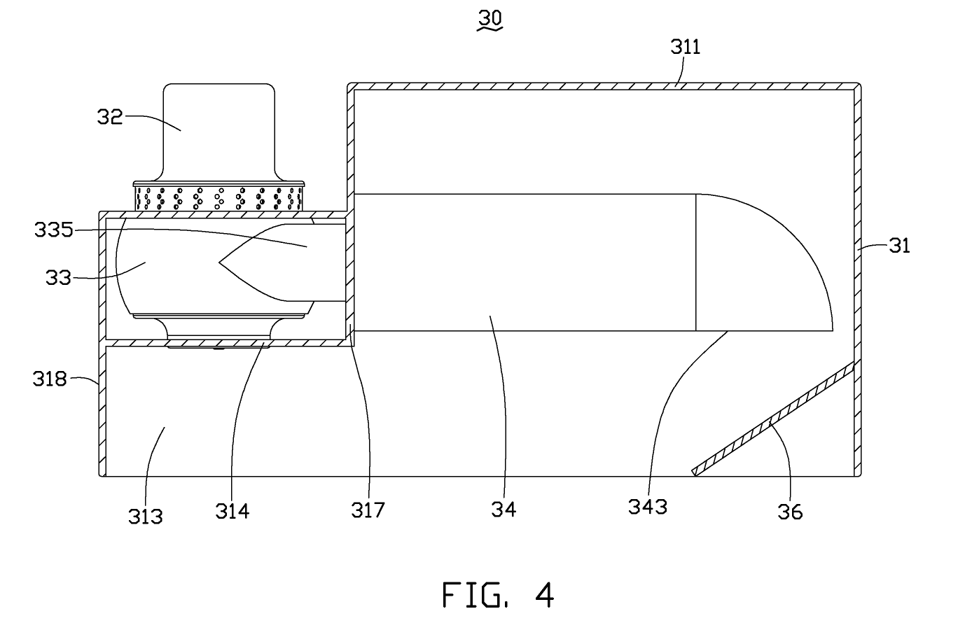

Referring to FIGS. 2 and 3, the oven 30 includes a box 31, a motor 32, a fan chamber 33, an air duct 34, a heater 35, and an air deflector 36. The box 31 includes a top plate 311, two sidewalls 312, and two end walls 318, 319. The two end walls 318, 319 face each other. The sidewalls 312, the end walls 318, 319, and the top plate 311 cooperatively define a cavity 313. The top plate 311 defines a fan hole 315 adjacent to the end wall 318. A supporting plate 314 is formed beneath the fan hole 315. The supporting plate 314 defines an opening 3142 facing the fan hole 315. Referring to FIG. 4, a baffle plate 317 adjacent to the end wall 318 connects the supporting plate 314 to the top plate 311. The baffle plate 317 defines a through hole 3172 allowing the air duct 34 to extend through.

The motor 32 is fixed in the fan hole 315 and includes a fan 321 at one end facing the opening 3142.

The fan chamber 33 includes a main body 331 and an air pipe 335 extending from one side of the main body 331. The main body 331 defines a receiving hole 332. The fan chamber 33 includes an inlet 334 at one end of the main body 331 and an outlet 336 at one end of the air pipe 335. The inlet 334 and the outlet 336 communicate with the receiving hole 332. The fan chamber 33 is attached to the supporting plate 314 under the fan hole 315 and the inlet 334 communicates with the opening 3142. The fan 321 of the motor 32 is received in the receiving hole 332. The air pipe 335 extends through the through hole 3172 of the baffle plate 317, and the outlet 336 faces the end wall 319.

The heater 35 includes a head portion 353 defining a center hole 3532. A plurality of heat pipes 351 are attached to the head portion 353 surrounding the center hole 3532. The heater 35 is electronically connected to the controller 20, and the heat pipes 351 can generate heat when the heater 35 receives electric current. The head portion 353 is fixed to the air pipe 335 of the fan chamber 33. The center hole 3532 communicates with the outlet 336.

The air duct 34 includes a first air hole 341 and a second air hole 343. An axis of the second air hole 343 is perpendicular to the first air hole 341. The air duct 34 is mounted on the heater 35 via the first air hole 341.

The air deflector 36 is oriented in the cavity 313, extending down at angle from the end wall 319. The air deflector 36 faces the second air hole 343.

In use, a workpiece is placed on the conveyor belt 15. The heating apparatus 100 is started using the controller 20. The conveyor belt 15 brings the workpiece under the cavity 313 of the box 31. The motor 32 drives the fan 321 to rotate. Air is drawn through the inlet 334 of the fan chamber 33 and expelled through the outlet 336 of the fan chamber 33. Air from the outlet 336 is heated by the heat pipes 351 and flows through the air duct 34. Air flows out from the second air hole 343 of the air duct 34 and is deflected by the air deflector 36. The hot air softens the plastic of the workpiece. The workpiece is then conveyed from the box 31 by the conveyor belt 15. At which time, the soft plastic can be easy separated from the metal.

It should be understood that since the hot air is deflected by the air deflector 36, the fan chamber 33 can re-circulate the hot air into the cavity 313. This is efficacious and environmental.

It is to be understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A heating apparatus comprising a oven, the oven comprising:
a box defining a cavity;
a motor including a fan, the motor attached to the box;
a fan chamber fixed in the cavity, the fan inserted into the fan chamber, the fan chamber defining an inlet and an outlet;
an air duct including a first air hole and a second air hole, the first air hole communicating with the outlet, the second air hole communicating with the cavity; and
a heater received in the air duct, the motor driving the fan to receive air from the inlet of the fan chamber and blowing the air into the air duct, the air heated by the heater and flowing from the second air hole.

2. The heating apparatus as claimed in claim 1, wherein the box further comprises a supporting plate, the supporting plate defines an opening, the fan chamber is attached to the baffle plate, and the inlet communicates with the opening.

3. The heating apparatus as claimed in claim 2, wherein the box further comprises an air deflector in the cavity facing the second air hole of the air duct.

4. The heating apparatus as claimed in claim 3, wherein the box further comprises a top plate, two end walls and two sidewalls cooperatively forming the cavity.

5. The heating apparatus as claimed in claim 4, wherein the top plate defines a fan hole adjacent to one of the two end walls, and the fan is inserted into the fan hole facing the opening of the baffle plate.

6. The heating apparatus as claimed in claim 5, wherein the air deflector at angle extends from the other end wall.

7. The heating apparatus as claimed in claim 6, wherein the box further comprises a baffle plat connecting the supporting plate to the top plate, and the baffle plate defines a through hole allowing the air dust to extend through.

8. The heating apparatus as claimed in claim 1, further comprising a frame, wherein a conveyor belt is attached to the frame, and the box is attached to the frame and positioned above the conveyor belt.

9. The heating apparatus as claimed in claim 8, further comprising a controller, wherein the controller controls the conveyor belt and the motor.

10. The heating apparatus as claimed in claim 1, wherein the heater comprises a head portion and a plurality of heat pipes, the head portion defines a center hole, and the heat pipes surround the center hole.

11. The heating apparatus as claimed in claim 10, wherein the fan chamber includes a main body, the main body defines a receiving hole receiving the fan, and the inlet and the outlet communicate with the receiving hole.

12. The heating apparatus as claimed in claim 11, wherein the fan chamber further includes an air pipe extending from the main body, the outlet is defined at one end of the air pipe, the head portion of the heater is attached to the air pipe, and the outlet communicate with the center hole.

13. A heating apparatus comprising:
a frame, a conveyor belt attached to the frame;
a oven attached to the frame and positioned above the conveyor belt, the oven comprising:
a box defining a cavity;
a motor including a fan, the motor attached to the box;
a fan chamber fixed in the cavity, the fan inserted into the fan chamber, the fan chamber defining an inlet and a outlet;
an air duct including a first air hole and a second air hole, the first air hole communicating with the outlet, the second air hole communicating with the cavity; and
a heater received in the air duct; and
a controller, the controller controlling the conveyor belt, the motor and the heater to work, the motor driving the fan to absorb air from the inlet of the fan chamber and blowing the air into the air duct, the air heated by the heater and flowing from the second air hole.

14. The heating apparatus as claimed in claim 13, wherein the box further comprises a supporting plate, the supporting plate defining an opening, the fan chamber is attached to the supporting plate, and the inlet communicates with the opening.

15. The heating apparatus as claimed in claim 14, wherein the box further comprises an air deflector in the cavity facing the second air hole of the air duct.

16. The heating apparatus as claimed in claim 15, wherein the box further comprises a top plate, two end walls and two sidewalls cooperatively forming the cavity.

17. The heating apparatus as claimed in claim 16, wherein the top plate defines a fan hole for adjacent to one of the two end walls, and the fan is inserted into the fan hole facing the opening of the baffle plate.

18. The heating apparatus as claimed in claim 17, wherein the air deflector at angle extends from the other end wall.

19. The heating apparatus as claimed in claim 13, wherein the heater comprises a head portion and a plurality of heat pipes, the head portion defines a center hole, and the heat pipes surround the center hole.

20. The heating apparatus as claimed in claim 19, the fan chamber includes a main body and an air pipe extending from the main body, the main body defines a receiving hole receiving the fan, the outlet is defined at one end of the air pipe, the inlet and the outlet communicate with the receiving hole, the head portion of the heater is attached to the air pipe, and the outlet communicate with the center hole.
